(19) United States
(12) Patent Application Publication
(10) Pub. No.: US 2011/0283520 A1
(43) Pub. Date: Nov. 24, 2011

(54) CERAMIC LAG BOLT AND USE THEREOF IN HIGH TEMPERATURE INSULATION INSTALLATION

(75) Inventor: MATTHEW L. PERRY, Zelienople, PA (US)

(73) Assignee: Stellar Canada, Inc., Burlington (CA)

(21) Appl. No.: 13/195,331

(22) Filed: Aug. 1, 2011

Related U.S. Application Data
(62) Division of application No. 12/335,303, filed on Dec. 15, 2008.
(60) Provisional application No. 61/013,875, filed on Dec. 14, 2007.

(51) Int. Cl. B23P 11/00

(52) U.S. Cl. 29/525.01

(57) ABSTRACT

A method for securing a hot face insulation to a cold face insulation of an enclosed heating area includes (a) providing a first insulating material having a first and second side; (b) providing a second insulating material having a first and second side, wherein the second insulating material provides for higher temperature insulation than the first insulating material, wherein the first side of the first insulating material is positioned against and secured to the interior surface of the enclosed heating area; (c) positioning the second insulating material against the first insulating material so that the first side of the second insulating material abuts the second side of the first insulating material; (d) providing an auger bolt as an anchor; and (e) inserting the auger bolt into the second side of the second insulating material, through the second insulating material, and into the second side of the first insulating material.

### CROSS REFERENCE TO RELATED APPLICATIONS

This application claims the benefit of U.S. Provisional Patent Application No. 61/013,875 filed Dec. 14, 2007, and entitled “Ceramic Lag Bolt and Use Thereof in High-Temperature Insulation Installation,” the contents of which are incorporated herein by reference. This application is a divisional of 12/335,303, filed on Dec. 15, 2008.

### BACKGROUND OF THE INVENTION

1. Field of the Invention

The present invention relates to a system and method for securing insulation to an enclosed heating area, such as a furnace or kiln and, more particularly, to a system and method for securing high temperature insulating material to a low temperature insulating material that is secured to an interior surface of such furnace or kiln.

2. Description of Related Art

The walls of a furnace, kiln, hot duct, or the like, are usually lined with ceramic fiber boards, blankets, insulating fire brick (IFB), and/or ceramic fiber modules for insulation purposes. In the prior art, there have been two commonly used systems for securing insulation to the steel casing of a furnace or kiln. The first system is typically referred to as a “wallpaper” or “layered blanket” system. This system involves welding anchors, such as metallic pins on a pre-determined pattern to the furnace casing, shell, or interior surface. The alloy of the metallic pin will vary depending on the furnace temperature, however, most all layered blanket systems are limited to a maximum temperature of <2150° F. since this is the upper use limit of conventional alloys currently being employed. The type and kind of material used for the pins is usually detelinined by the overall cost associated with a particular furnace implementation, including the insulation and the operating temperature of the furnace. As a general rule, when the process temperatures increase, more costly insulating materials and anchoring systems must be employed to withstand the extreme temperatures and corrosive conditions associated in such environments.

Once all metallic pins are welded, layer after layer of insulating blankets or boards are impaled over the pins to the desired thickness and secured with an alloy clip after the last layer is applied. Both the end of the pin and securing clip are directly exposed to furnace temperatures, thus greatly limiting the maximum temperatures where this system can be used. Regarding the insulation, the first insulation layers applied (which are closest to the furnace casing) are commonly lower cost mineral boards or blankets. Each subsequent layer will typically be of higher cost, quality and density RCF (Refractory Ceramic Fiber) or non-RCF (bio-soluble) blankets or boards. The final or “hot face” layer will be of sufficient quality and chemistry to withstand the direct temperature exposure of the furnace. For temperatures above the use limit of metallic pins, ceramic spikes or cones are frequently substituted. The ceramic studs are secured to a metallic holder that is again welded to the casing of the furnace. While different in composition, both the metallic or ceramic pins originate at the steel casing, require a pre-layout to install, and are extremely difficult, if not impossible to repair if damaged. In addition, as temperatures increase, the cost of the pins will increase as well as better alloys or ceramics must be used to survive the high temperatures found in various furnaces, kilns, or heaters. While the “wallpaper” system is limited to the capability of the anchor, it should also be noted that this system provides the best thermal barrier to heat loss when compared to alternate systems of similar thickness and density. This is a result of the lining materials being perpendicular to the flow of heat and that the layered blanket system permits the seams of each layer to be staggered or broken so there can never be a direct path of heat to the furnace casing. This feature of layered systems has been well documented in both computer models and actual field installations.

The second system commonly employed utilizes an insulation module where the anchoring hardware is embedded close to the furnace casing. Anchor temperatures are greatly reduced since they are embedded in the insulation and thus protected from direct furnace temperatures. While the embedded anchor allows a module system to be used at temperatures higher than the “wallpaper” system discussed above, the vast majority of module systems require the same high temperature insulation be used through the full thickness of the lining. This inability to use lower temperature, less costly insulation at the cooler depths of the lining thickness results in costs which can be significantly higher (e.g., 23 times higher) than “wallpaper” systems. In addition, the insulation of a module system is predominantly oriented parallel to the heat path, thus making it less efficient than “wallpaper” systems. Further, since there are no staggered layers in a module lining, there is a potential for a direct heat path to the furnace casing surrounding each module should the lining be compromised by mechanical damage, chemical attack, and/or heat related shrinkage.

In some cases, ceramic fiber modules are veneered to existing refractory linings utilizing a high temperature mortar. These mortared-on veneering modules frequently fall off due to differences in expansion at the mortar joint, poor bonding, or improper installation. In the case of full thickness module linings, there is a straight through joint surrounding every module that may provide a direct path for heat, should the module experience heat-related shrinkage, mechanical damage, or poor installation practices.

It is, therefore, desirable to overcome the above problems and others by providing a system and method for efficiently and effectively securing high temperature insulating material to low temperature insulating material. It is also desirable to have the ability to add additional fuel saving staggered layers of insulation to existing linings without the added cost of extending the anchor length.

### SUMMARY OF THE INVENTION

Accordingly, the present invention includes a high temperature resistant anchor for mechanically securing high temperature insulation to low temperature insulation materials, which have already been attached to an interior surface of an enclosed heating area, such as a kiln, furnace, incinerator, process heater, fuel cell, or other heat processing equipment.

The anchor may be embodied as a ceramic lag bolt, auger, corkscrew, or other suitable implement. In contrast to the prior art insulation attachment implementations that initiate at the cooler equipment casing or shell, the system of the present invention originates at an opposing hot side of the lining of the furnace. Thus, the present invention provides for a system and method for securing a hot face lining to a cold face lining. Additionally, the present invention combines the benefits of both the “wallpaper” system and the module system, which results in a lower cost and more thermally efficient lining with broken or staggered seams to combat the flow of heat.

In one embodiment, the present invention includes a method for securing a hot face insulation to a cold face insulation attached to an interior surface of an enclosed heating area such as a kiln or furnace. The steps include (a) providing a first insulating material having a first and second side; (b) providing a second insulating material having a first and second side, wherein the second insulating material provides for higher temperature insulation than the first insulating material, wherein the first side of the first insulating material is positioned against and secured to the interior surface of the enclosed heating area; (c) positioning the second insulating material against the first insulating material so that the first side of the second insulating material abuts the second side of the first insulating material; (d) providing an anchor; and (e) inserting (e.g. screwing in) the anchor into the second side of the second insulating material, through the second insulating material, and into the second side of the first insulating material such that the second insulating material is secured to the first insulating material, and wherein the anchor is not attached to the interior surface of the enclosed heating area. The anchor may be constructed only of ceramic (e.g., any nonmetallic, inorganic, burnt material) or at least ceramic with other materials. The anchor may be of composite construction such that the anchor includes a head consisting of the ceramic and a threaded portion consisting of metal. The anchor may have a threaded portion, as is the case with a screw bolt or an auger bolt.

Any damage that has occurred to the high temperature insulation may be remedied by simply removing that damaged section of insulation and securing a piece of functional insulation to the underlying low temperature material via the anchor, or ceramic screw bolt. Any existing ceramic screw bolts that have been damaged may simply be removed and replaced with new ceramic screw bolts. The use of ceramic screw bolts for attaching the high temperature insulation to the low temperature material provides for timely and cost-effective maintenance of the interior of the furnace.

Accordingly, the present invention may be implemented in connection with new lining applications where a more cost-effective, reliable, and repairable system is desired, or with existing lining applications where additional insulation is required or repairs are needed. For example, the present invention includes a method for replacing a damaged portion of a hot face insulation of an enclosed heating area, wherein the hot face insulation and a cold face insulation are attached to a first anchor extending from an interior surface of the enclosed heating area. This method includes the steps of (a) removing the damaged portion of the hot face insulation resulting in a portion of the cold face insulation to be exposed; (b) providing a replacement hot face insulation that substantially corresponds to the size of the damaged portion of the hot face insulation; (c) positioning the replacement hot face insulation against the exposed cold face insulation; (d) providing a second anchor; and (e) inserting the second anchor into the replacement hot face insulation, through the replacement hot face insulation, and into the cold face insulation such that the replacement hot face insulation is secured to the previously exposed cold face insulation.

The present invention may also encompass other applications of use of the aforementioned ceramic screw bolts. For example, a method for securing a heating element to an interior insulation of a furnace/kiln includes the steps of: (a) providing a plurality of ceramic screw bolts each having a shank; (b) screwing the plurality of ceramic screw bolts partially into the interior insulation such that a portion of each of the ceramic screw bolts extends out of the interior insulation; and (c) positioning the heating element along the interior insulation by supporting respective portions of the heating element on each of the ceramic screw bolts.

Still other desirable features of the invention will become apparent to those of ordinary skill in the art upon reading and understanding the following detailed description, taken with the accompanying drawings, wherein like reference numerals represent like elements throughout.

### BRIEF DESCRIPTION OF THE DRAWINGS

FIG. 1a is a front plan view of a ceramic bolt in accordance with the present invention;

FIG. 1b is a front plan view of a ceramic auger bolt in accordance with the present invention;

FIG. 1c is a front plan view of a ceramic corkscrew in accordance with the present invention;

FIG. 1d is a front plan view of a composite ceramic and metallic anchor bolt in accordance with the present invention;

FIG. 2 is a sectional view of a high temperature insulation secured to a low temperature material by one or more of the ceramic bolts of FIG. 1, in accordance with the present invention;

FIG. 3 is a perspective cutaway view of the of the high temperature insulation to low temperature material interface of FIG. 2, in accordance with the present invention;

FIG. 4 is a perspective cutaway view of a high temperature insulation secured to insulating fire brick;

FIG. 5a is a side plan view of ceramic bolts of FIG. 1 used to secure a baffle curtain in a roof insulation application;

FIG. 5b is a perspective view of the baffle curtain with ceramic bolts secured thereto, as shown in FIG. 5a;

FIG. 6a is a side plan view of an alternative embodiment of the present invention in which electric heating element using ceramic bolts of FIG. 1 are used to hang electric heating elements; and

FIG. 6b is a perspective view of the electric heating elements hung by the ceramic bolts, as shown in FIG. 6a.

### DESCRIPTION OF THE PREFERRED EMBODIMENTS

The present invention will now be described with reference to the accompanying figures. It is to be understood that the specific system and applications illustrated in the attached figures and described in the following specification are simply exemplary embodiments of the present invention. Hence, specific dimensions and other physical characteristics related to the embodiments disclosed herein are not to be considered as limiting.

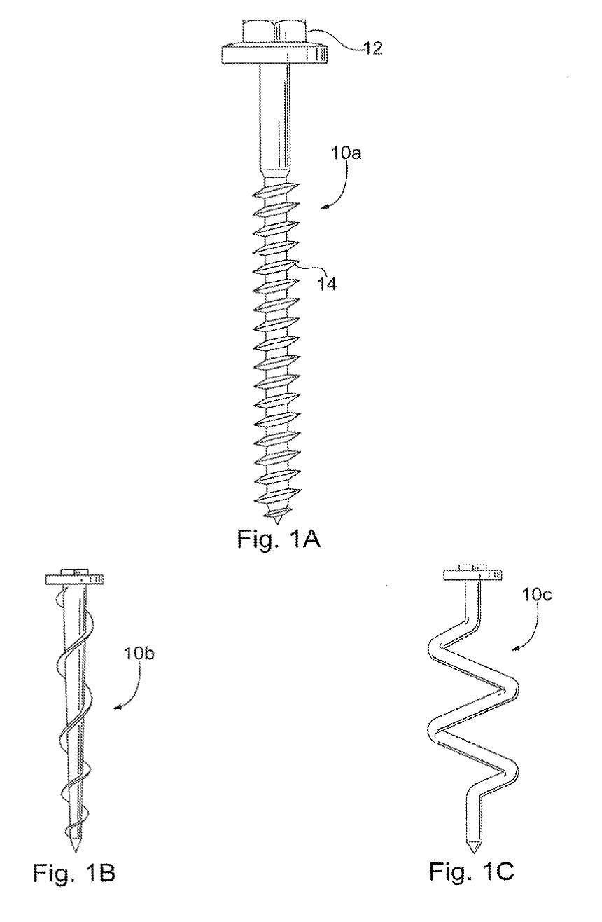

FIG. 1 a depicts an anchor, embodied as a ceramic lag bolt 10a. In a desirable embodiment, the ceramic lag bolt 10a includes a drive head 12 and a shank 14. In one embodiment, the ceramic lag bolt 10a may be 8″ to 10″ in length. The ceramic material is such that it can withstand high temperatures within a furnace, kiln, or other high temperature environment. One exemplary ceramic material may be any non-metallic, inorganic, burnt material, however, it is to be understood that other suitable materials may be utilized. The drive head 12 may be of any size, shape, and dimension suitable for allowing an external drive member (e.g., nut driver) to interface therewith. The shank 14 may be threaded or, more specifically, include a tapered threading. It is to be understood that other suitably adapted shanks may be utilized, including, but not limited to a barbed-tapered configuration (not shown).

The present invention also encompasses other types of anchors. For example, as shown in FIG. 1b, an anchor may be in the form of an auger bolt 10b having a deeper thread than that of the bolt in FIG. 1a. The auger bolt 10b may be used with low (e.g., <8 pcf) or higher density (e.g., >8 pcf) linings. An anchor may alternatively be in the fomi of corkscrew-type design as shown in FIG. 1c. Each of the aforementioned various embodiments may be of ceramic material or other high temperature resistant material. In still another embodiment, an anchor may be in the form of a composite anchor, such as a ceramic and metallic anchor bolt 10d as shown in FIG. 1d. Such a composite anchor may include two separate sections of the anchor made of different material. For example, the ceramic and metallic anchor bolt 10d includes a head and shank made of ceramic, whereas the threaded portion of the shank is made of metal. Use of different materials may reduce manufacturing costs or address other constraints. It is to be understood that different combination of suitable material may be used in a composite anchor. Additionally, it is to be understood that the threaded portion of composite anchor may embody and of the aforementioned various designs discussed in connection with FIGS. 1a, 1b, and 1c.

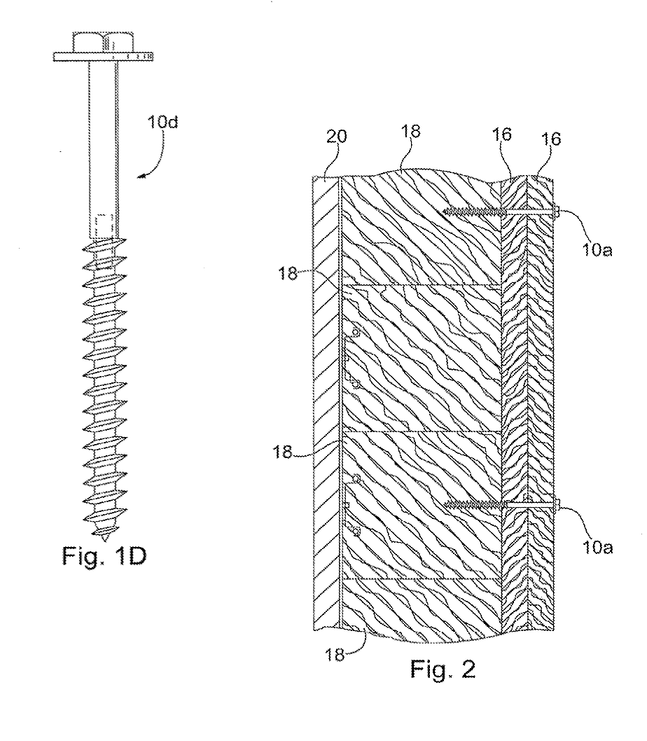

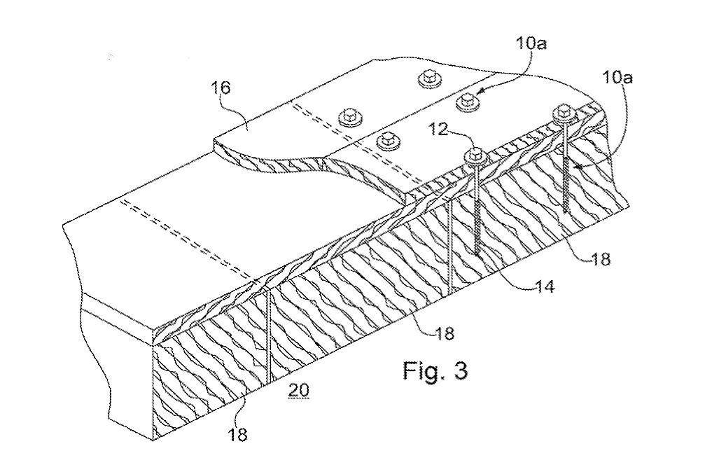

FIGS. 2 and 3 depict a hot face lining, or high temperature insulation 16, secured to a cold face lining, or low temperature material 18, via ceramic lag bolts 10a. As is known in the art, the low temperature material 18 may be of any suitable material such as fiber board, blankets, insulating firebrick (IFB), refractory, and/or ceramic fiber modules or blocks. The low temperature material 18 may be secured to a shell 20 or interior surface of the furnace in any known conventional manner. As shown in the drawings, the ceramic lag bolts 10a may be threaded through or screwed into the high temperature insulation 16 and into the low temperature material 18, thereby, securing the high temperature insulation 16 to the low temperature material 18 without any direct connectivity to the shell 20.

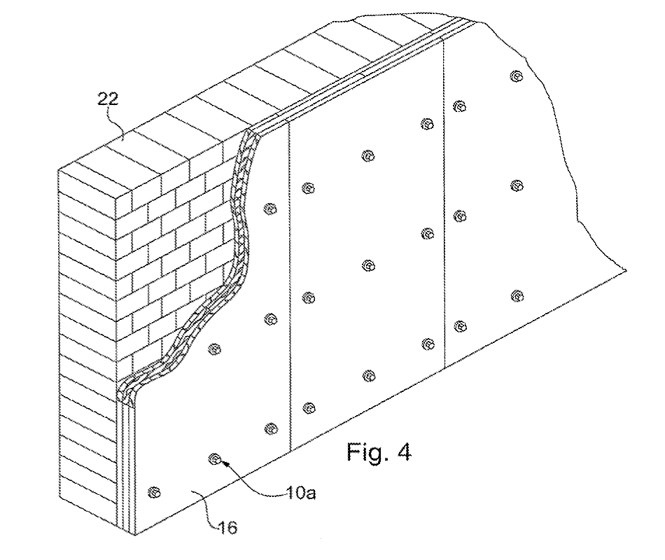

It is to be understood that the attachment implementation may be applied in the context of walls, ceilings, and other surfaces in a furnace application that require connection between a hot face lining and a cold face lining. For example, as shown in FIG. 4, the ceramic lag bolts 10a may be used to secure the high temperature insulation 16 directly to insulating firebrick 22 of a kiln. Thus, hot face veneer insulation may be mechanically anchored to existing or new insulating firebrick, refractory castables, plastics, or other refractory materials. This mechanical anchoring overcomes the adhesion issues commonly associated with existing glued or mortared veneering systems.

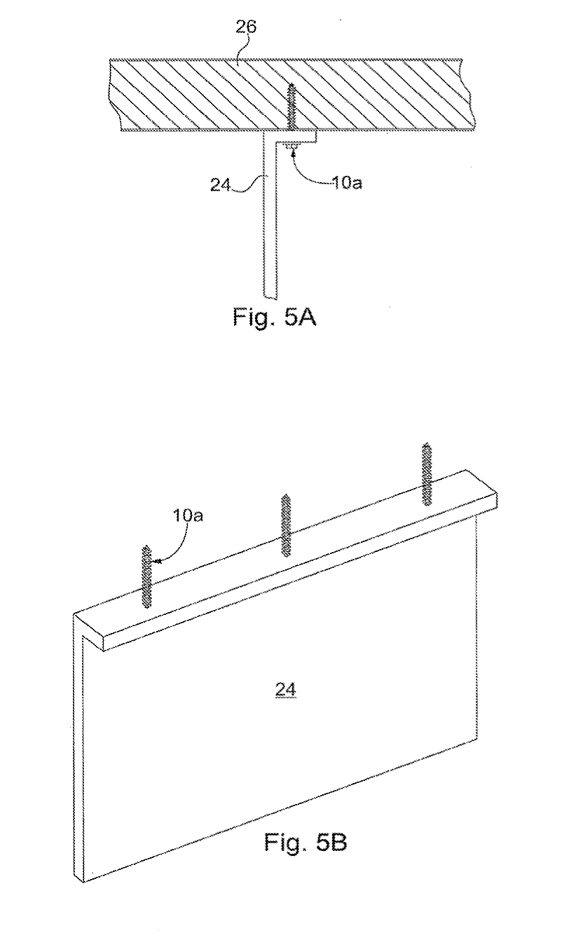

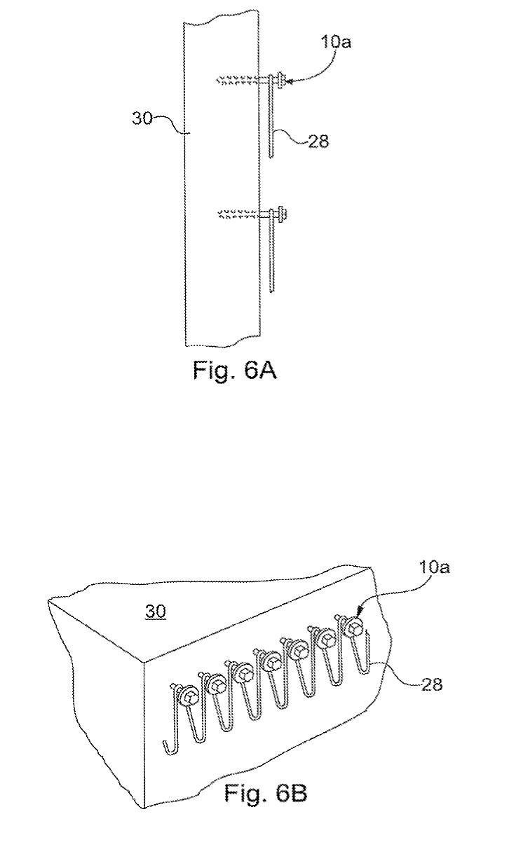

It is to be understood that the aforementioned system may be used to secure, anchor, or hang other furnace or kiln-related components in high temperature environments. For example, FIGS. 5a and 5b depict the use of the ceramic lag bolts 10a to secure a baffle curtain or zone divider 24 to a roof 26 of the furnace or kiln. FIGS. 6a and 6b depict the hanging of electric heating elements 28 via the ceramic lag bolts 10a to an insulation lining 30 of the furnace or kiln.

It is also to be understood that other similar hot face lining to cold face lining implementations may be realized that are in keeping with the scope of the present invention. For example, in an alternative embodiment, the ceramic lag bolt 10a or other fastener may be provided with additional securing strength via the addition of mortar, specialized glue, or other suitable adhering substance used in conjunction with the mechanical fastening provided by the ceramic lag bolt 10a (e.g., adding the adhering substance to the anchor prior to screwing in thereof).

The invention has been described with reference to the desirable embodiments. Modifications and alterations may occur to others upon reading and understanding the preceding detailed description. It is intended that the invention be construed as including all such modifications and alterations insofar as they come within the scope of the appended claims or the equivalents thereof.

What is claimed is:

1. A method for securing a hot face insulation to a cold face insulation, the cold face insulation being attached to an interior surface of a shell of an enclosed hearing area, the method comprising the steps of:
(a) attaching a first insulation material to the interior surface of the shell, the first insulation material being the cold face insulation;
(b) positioning a second insulation material over a second side of the first insulation material, the second insulation material being the hot face insulation; and
(c) securing the second insulation material to the first insulation material by inserting an auger into and through the second insulation material and into and only partially through the first insulation material, so as to secure the second insulation material to the first insulation material without securing the second insulation material to the outer shell and without first preparing a securement means for the anchor, wherein the single-piece auger has no moving parts.

2. The method of claim 1, wherein the auger is constructed only of ceramic.

3. The method of claim 1, wherein the auger is constructed at least partially of ceramic.

4. The method of claim 3, wherein the ceramic is any non-metallic, inorganic material.

5. The method of claim 1, further comprising the step of adding an adhering substance to the auger prior to implementing the auger.

6. The method of claim 1, wherein the enclosed heating area is a kiln, furnace, incinerator, process heater, or fuel cell.

7. The method of claim 1, wherein the first insulating material is fiber board, a blanket, insulating firebrick, a refractory block, or a ceramic fiber module.
